(19) United States
(12) Patent Application Publication
(10) Pub. No.: US 2010/0326150 A1
(43) Pub. Date: Dec. 30, 2010

(54) CYLINDER LOCK

(76) Inventor: Shu-Ling CHUNG, Neipu Township (TW)

Correspondence Address: SINORICA, LLC, 2275 Research Blvd., Suite 500, ROCKVILLE, MD, 20850, US

(21) Appl. No.: 12/494,180

(22) Filed: Jun. 29, 2009

(51) Int. Cl. E05B 27/00; E05B 9/00

(52) U.S. Cl. 70/491; 70/448

(57) ABSTRACT

A cylinder lock includes a cylinder lock casing comprising an axial cavity, two opposite lengthwise grooves on the cavity, and an upper riser including aligned upper holes being in communication with the cavity; a cylinder lock core releasably fastened in the cylinder lock casing and comprising a key hole, top lower holes, and a side slot being in communication with the key hole, a locking tumbler comprising cylindrical lower tumbler elements slidably disposed in the lower holes, each lower tumbler element partially extended into the key hole and including an outer longitudinal trough, and spring depressible upper tumbler elements in the upper holes and partially disposed in the lower holes to contact with the lower tumbler element; and a spring depressible side bar in the slot and comprising inner ribs and a longitudinal outer protrusion in one groove.

### BACKGROUND OF THE INVENTION

1. Field of Invention

The invention relates to cylinder locks and more particularly to a cylinder lock with improved characteristics including increased anti-picking performance.

2. Description of Related Art

Cylinder locks have been used for many years. There have been numerous suggestions in prior patents for cylinder locks. For example, U.S. Pat. No. 4,154,070 discloses a lock that causes insertion of multiple bolts into the jamb surrounding the door in multiple directions. The disadvantage of this patent is that in order to install the device, a large section of the door interior volume needs to be removed, which is a difficult, time consuming and expensive process. In addition, the door structure itself is substantially weakened, reducing overall security. The lock is made of thin sheet metal and is not strong enough.

U.S. Pat. No. 6,490,898 discloses a cylinder lock including a cylinder having a series of locking tumblers which are rotatably mounted around respective axes. The introduction of the key causes rotation of each locking tumbler to an operative position in which the tumblers enable the disengagement of a locking member carried by the cylinder from a seat formed in the stator of the lock.

Further, conventional cylinder locks are inclined to be picked by unauthorized persons by inserting a metal wire, tweezers, or the like into the key hole by rotating the cylinder lock core.

Thus, continuing improvements in the exploitation of cylinder lock are constantly being sought.

### SUMMARY OF THE INVENTION

It is therefore one object of the invention to provide a cylinder lock having an improved anti-picking performance.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of cylinder lock according to the invention;

FIG. 2 is a sectional view taken along line A-A of FIG. 1;

FIG. 3 is an exploded view of a second preferred embodiment of cylinder lock according to the invention where the cylinder lock core, the locking tumbler, and the side bar of a first configuration are illustrated;

FIG. 4 is an enlarged view of a central portion of FIG. 3 where the cylinder lock core, the locking tumbler, and the side bar of a second configuration are illustrated;

FIG. 5 is an enlarged view of a central portion of FIG. 3 where the cylinder lock core, the locking tumbler, and the side bar of a third configuration are illustrated;

FIG. 6 is a sectional view taken along line B-B of FIG. 5;

FIG. 7 is an exploded perspective view showing the key to be inserted into the cylinder lock core and the locking tumbler to be inserted into the holes of the cylinder lock core, respectively where both the cylinder lock core and the locking tumbler are of the first configuration;

FIG. 8 is an exploded perspective view of a cylinder lock core, a key, two side bars, and a locking tumbler according to a third preferred embodiment of the invention;

FIG. 9 is a sectional view taken along line C-C of FIG. 8;

FIG. 10 is a sectional view taken along line D-D of FIG. 8;

FIG. 11 is an exploded perspective view of a cylinder lock core, a key, two side bars, and a locking tumbler according to a fourth preferred embodiment of the invention; and

FIG. 12 is a view similar to FIG. 11 but viewed from the other opposite side.

### DETAILED DESCRIPTION OF THE INVENTION

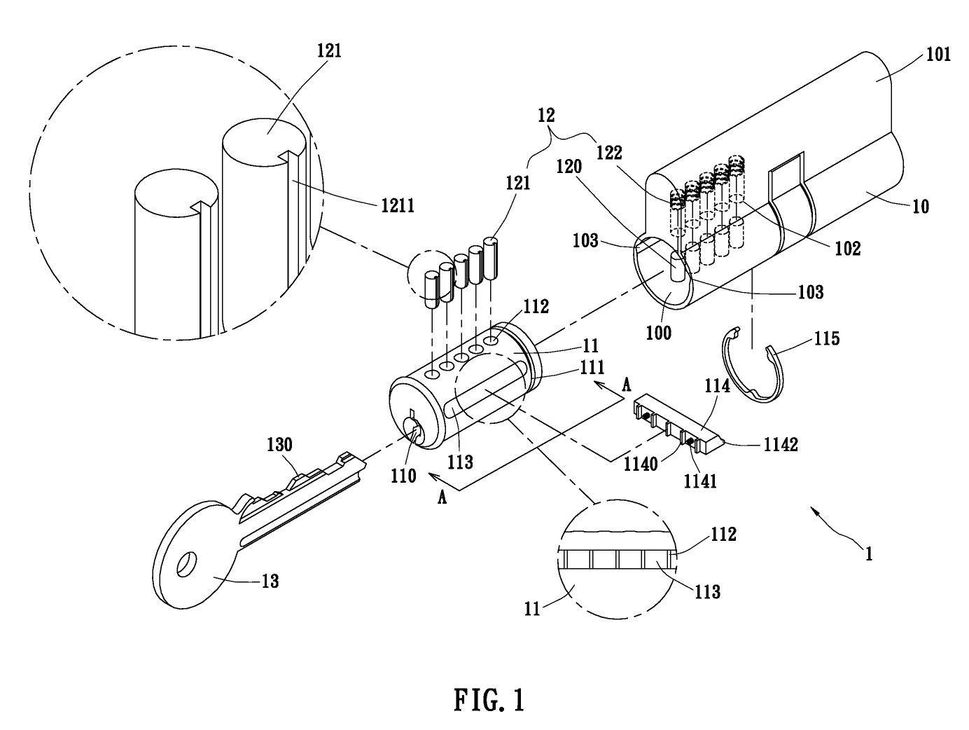

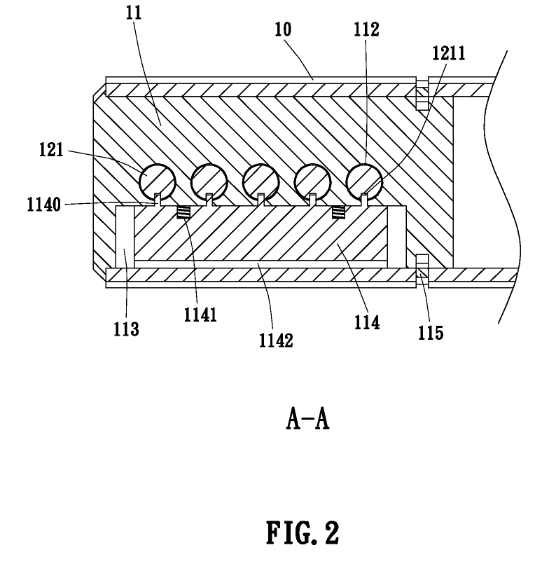

Referring to FIGS. 1 and 2, a cylinder lock 1 in accordance with a first preferred embodiment of the invention is shown. The cylinder lock 1 comprises the following components as discussed in detail below.

A cylinder lock casing 10 is intended to be mounted in, for example, a door to be locked in relation to a frame. Alternatively, the cylinder lock casing 10 may constitute a padlock. The cylinder lock casing 10 comprises an axially extending cavity 100 of circular cross-section, two opposite lengthwise grooves 103 on an upper portion of an inner surface of the cavity 100, and a lengthwise riser 101 extending upward from the cavity 100, the riser 101 having a top of arc cross-section and having a plurality of (e.g., five) upper holes 102 aligned along and being in communication with a top of the cavity 100.

A cylindrical cylinder lock core 11 is rotatably fitted in the cavity 100 and comprises a key hole 110 on an outer end surface, an annular groove 111 proximate an inner end surface, a plurality of (e.g., five) lower holes 112 aligned along a top, a longitudinal slot 113 on one side of an outer surface, the slot 113 being in communication with the key hole 110, and a C-ring 115 put on the groove 111 to secure the cylinder lock core 11 and the cylinder lock casing 10 together (see FIG. 2).

A locking tumbler 12 comprises a plurality of (e.g., five) cylindrical lower tumbler elements 121 each having a longitudinal trough 1211 on an outer surface, a plurality of (e.g., five) upper holes 102 in the riser 101, a plurality of (e.g., five) upper tumbler elements 120 in lower portions of the upper holes 102, and a plurality of (e.g., five) helical springs 122 each anchored between an inner end of the upper tumbler element 120 and a blind end of the upper hole 102 for pushing the upper tumbler element 120 to contact the lower tumbler element 121.

An elongated side bar 114 has a substantially trapezoidal cross-section and comprises a plurality of (e.g., five) ribs 1140 equally spaced on an inner side, and a plurality of (e.g., two) helical springs 1141 in which one helical spring 1141 is provided between two front ribs 1140 and the other helical spring 1141 is provided between two rear ribs 1140. The side bar 114 further comprises a longitudinal protrusion 1142 on an outer side.

In an assembled state of the cylinder lock 1 (i.e., the cylinder lock core 11 assembled in the cavity 100), the upper tumbler elements 120 are pushed down by the springs 122 to partially dispose in the lower holes 112 with the lower tumbler elements 121 partially extending out of the lower holes 112 into the key hole 110 (i.e., the lower tumbler elements 121 being only permitted to move vertically in the lower holes 112). Hence, the cylinder lock core 11 is prohibited from rotating in the cavity 100 (i.e., a rotational movement of the cylinder lock core 11 about the cylinder lock casing 10 is prohibited). As a result, the cylinder lock 1 is locked. Also, the side bar 114 is provided in the slot 113 with the helical springs 1141 urged against an inner surface of the key hole 110 to push the ribs 1140 away from the troughs 1211. Hence, the protrusion 1142 enters one groove 103.

An opening operation of the invention will be described in detail below. A user may fully insert a key 13 into the key hole 110 to cause its teeth 130 to push the lower tumbler elements 121 upward. As such, the upper tumbler elements 120 clear the lower holes 112 (i.e., at about the circumferential surface of the cylinder lock core 11). At this position, the key 13, the cylinder lock core 11, and the lower tumbler elements 121 can act (i.e., rotate) as a whole. Next, the user may turn the key 13 counterclockwise. As a result, the counterclockwise rotating protrusion 1142 clears one groove 103 to retract into the slot 113 (i.e., the side bar 114 moves radially toward an axial axis of the cylinder lock core 11). At the same time, the helical springs 1141 compress to move the ribs 1140 into the troughs 1211. The upper tumbler elements 120 will not fall into the slot 113 during the rotation since a diameter of the upper tumbler element 120 is sufficiently larger than a width of the slot 113. The operation will be stopped when the protrusion 1142 enters the other groove 103 due to the sudden expansion of the helical springs 1141. At the end of the operation, a bolt (not shown) driven by the rotating cylinder lock core 11 may unlock an object (e.g., door) where the cylinder lock casing 10 is mounted. At the same time, the side bar 114 moves radially away from the axial axis of the cylinder lock core 11 to cause the ribs 1140 to clear the troughs 1211.

The opening operation discussed above may be traversed in opposite direction to dispose the protrusion 1142 in one groove 103 again. Thereafter, the user may pull out the key 130 to dispose the lower tumbler elements 121 and the upper tumbler elements 120 in positions of the locking state. As a result, the cylinder lock 1 is locked again.

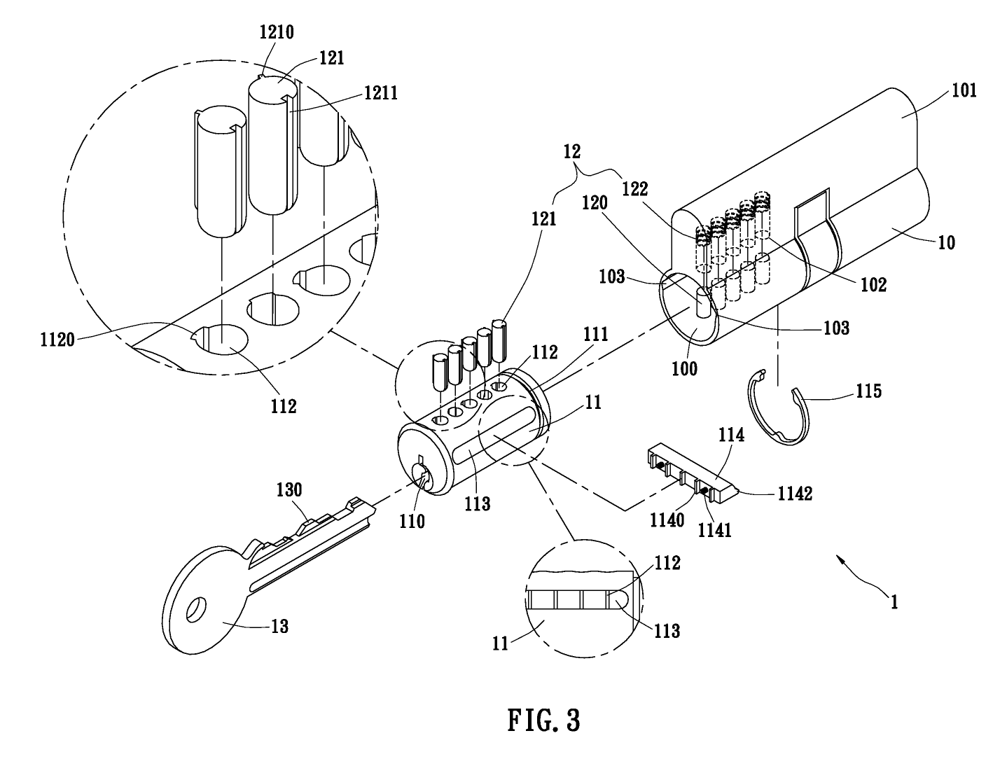

Referring to FIGS. 3 to 7, a cylinder lock in accordance with a second preferred embodiment of the invention is shown. The characteristics of the second preferred embodiment are detailed below.

In FIG. 3, a first configuration of the second preferred embodiment is illustrated. Each lower tumbler element 121 has a longitudinal trough 1211 on an outer surface and a longitudinal ridge 1210 opposite the trough 1211. Each lower hole 112 has a longitudinal trough 1120 shaped in conformity to the ridge 1210 to receive same therein.

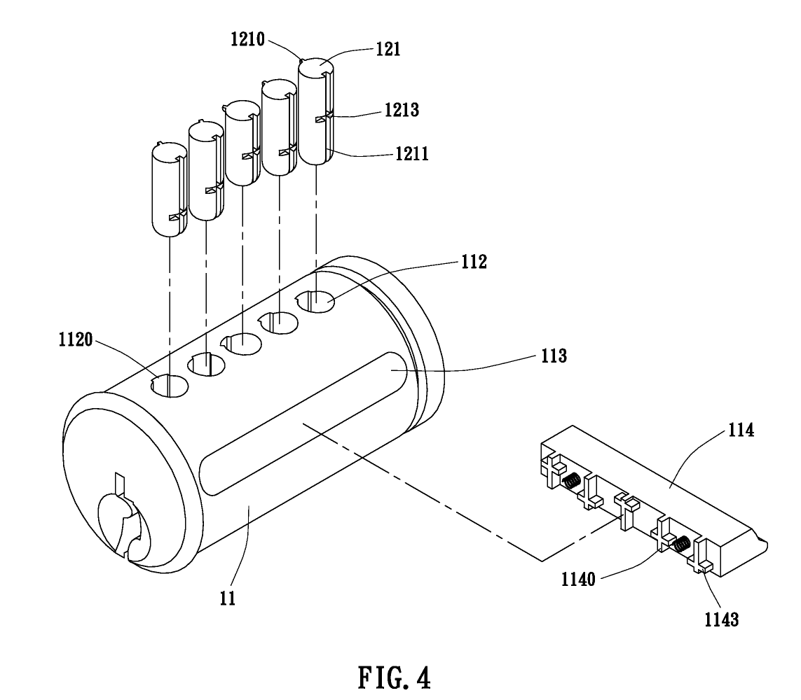

In FIG. 4, a second configuration of the second preferred embodiment is illustrated. Each lower tumbler element 121 has a longitudinal trough 1211 on an outer surface, a longitudinal ridge 1210 opposite the trough 1211, and a short horizontal cut crossing the trough 1211 to form a cross 1213 at the joining point. But the cross 1213 of one lower tumbler element 121 has an elevation different from that of the adjacent lower tumbler element 121. Each lower hole 112 has a longitudinal trough 1120 shaped in conformity to the ridge 1210 to receive same therein. The side bar 114 has a plurality of (e.g., five) ribs 1140 equally spaced on an inner side and a plurality of short horizontal protrusions each crossing the rib 1140 to form a cross 1143 at the joining point. The crosses 1143 are shaped in conformity to the mated crosses 1213 so as to engage therewith. But any two adjacent protuberances 1140 are not the same in shape.

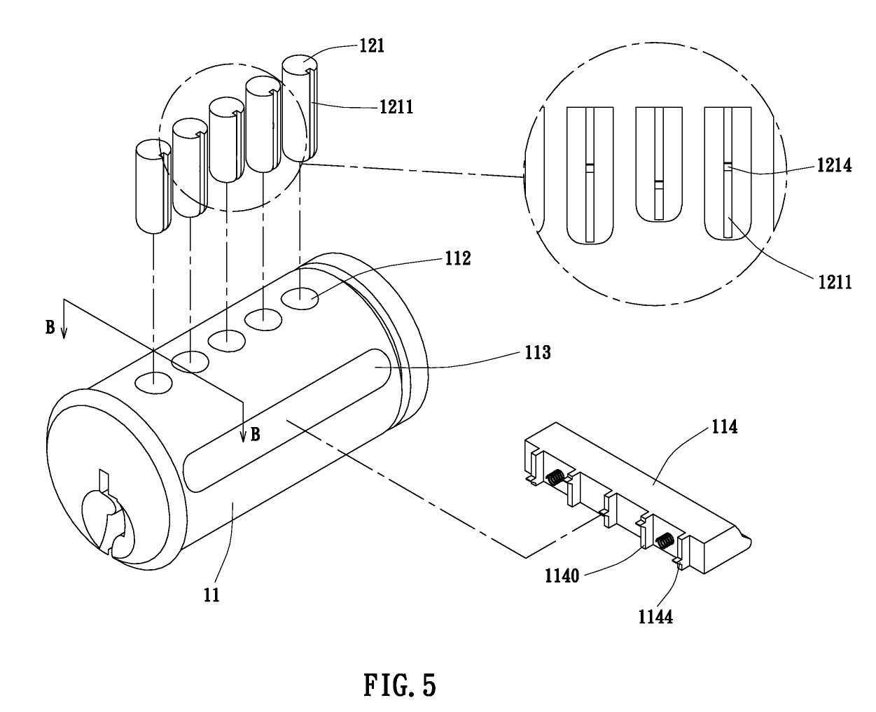

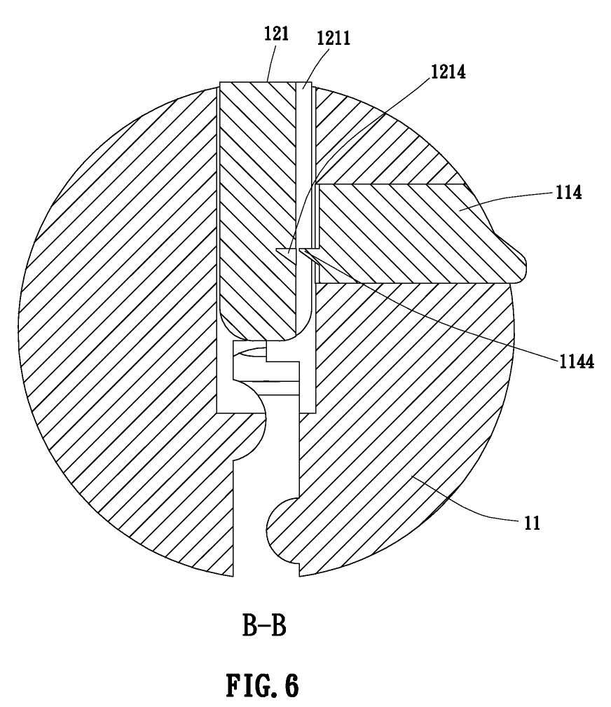

In FIGS. 5 and 6, a third configuration of the second preferred embodiment is illustrated. Each lower tumbler element 121 has a longitudinal trough 1211 on an outer surface, and a recess 1214 on the trough 1211. Any two adjacent recesses 1214 have different elevations. The side bar 114 has a plurality of (e.g., five) ribs 1140 equally spaced on an inner side, and a plurality of (e.g., five) sharp projections 1144 each formed on the rib 1140. The sharp projections 1144 are adapted to matingly engage with the recesses 1214, respectively.

The three configurations aim to increase the anti-picking performance of the cylinder lock.

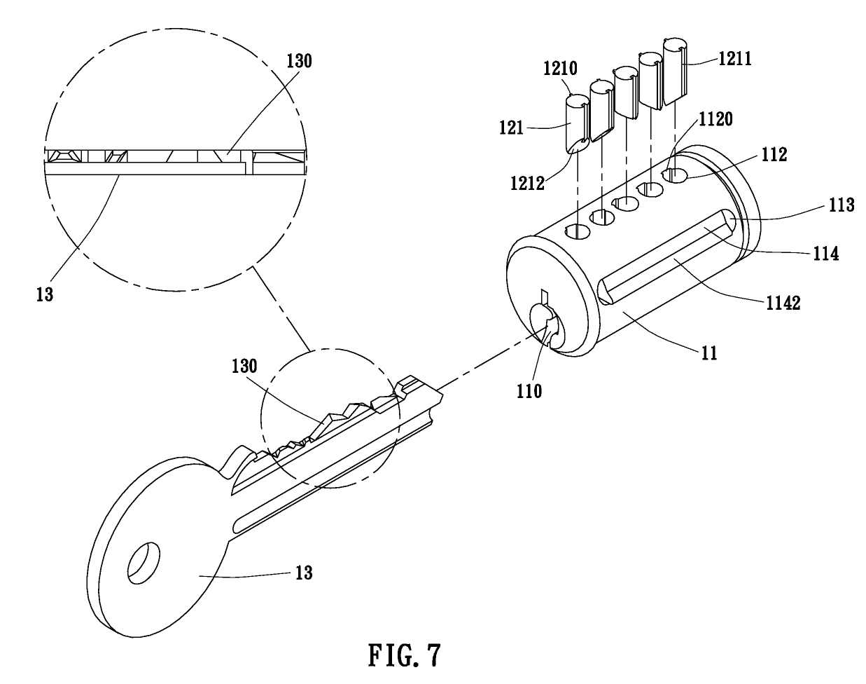

As shown in FIG. 7, the lower tumbler elements 121 are the same as that described in FIG. 3 except that an inclined surface 1212 is formed on a bottom end of each lower tumbler element 121. The inclined surfaces 1212 may be not the same in slope. But the inclined surfaces 1212 are shaped in conformity to the teeth 130 of the key 13. This arrangement can facilitate the engagements of the ribs 1140 and the troughs 1211 by causing the teeth 130 to push the inclined surfaces 1212 upward after the insertion of the key 13 into the key hole 110.

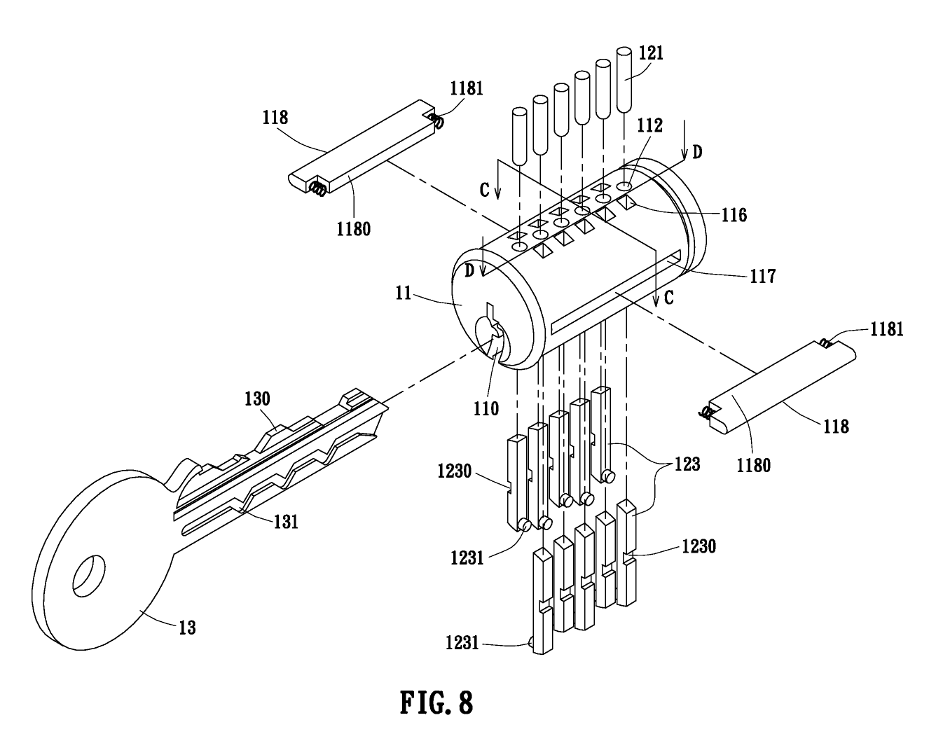

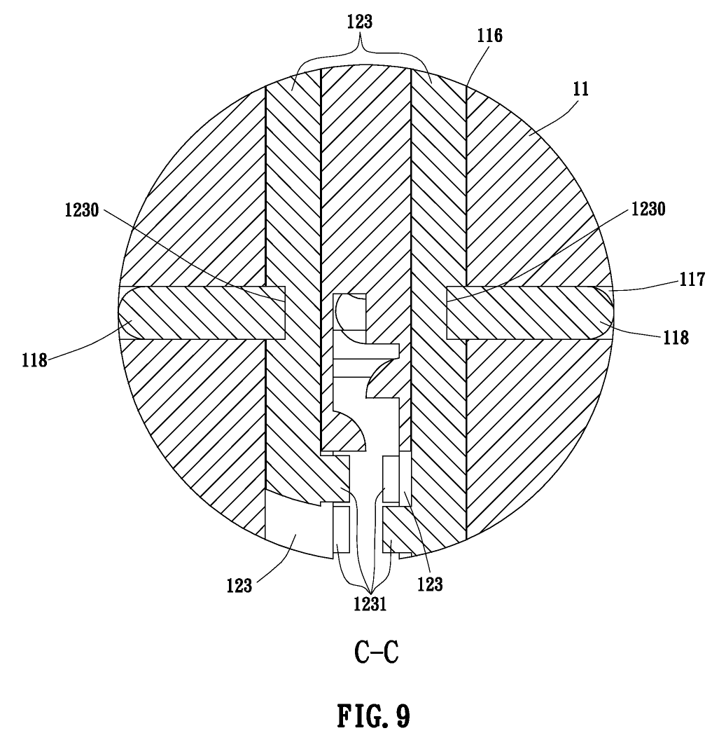

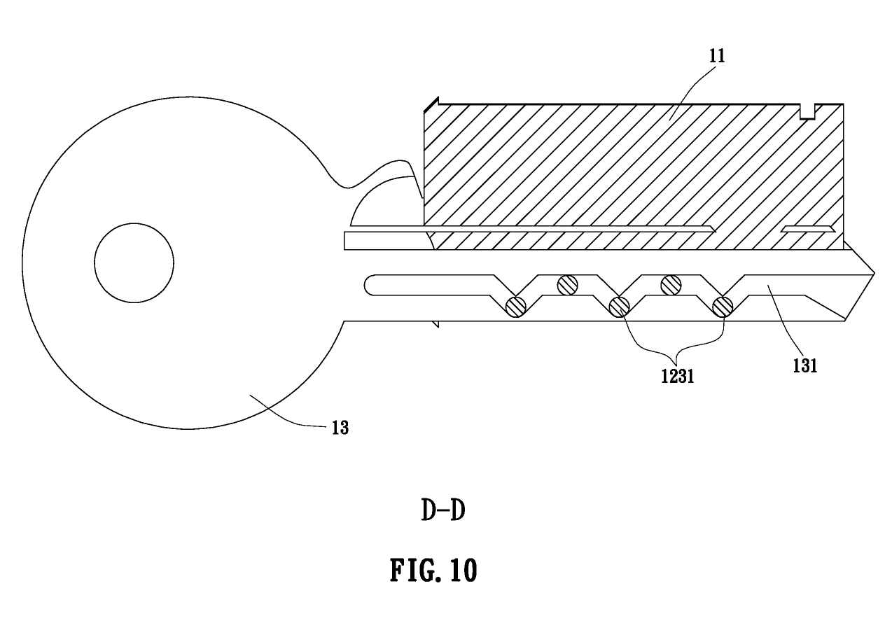

Referring to FIGS. 8 to 10, a cylinder lock in accordance with a third preferred embodiment of the invention is shown. The characteristics of the third preferred embodiment are detailed below. Note that a cylinder lock casing and a plurality of spring depressible upper tumbler elements of the cylinder lock of the third preferred embodiment are constructed the same as that described in the first preferred embodiment. Hence, description of the cylinder lock casing and the spring depressible upper tumbler elements of the cylinder lock of the third preferred embodiment are omitted herein for the sake of brevity only. The cylinder lock core 11 comprises a plurality of (e.g., six) lower holes 112 aligned along a top, two sets of a plurality of (e.g., five) aligned auxiliary holes 116 at both sides of the lower holes 112, respectively. Six lower tumbler elements 121 are movably disposed in the lower holes 112. Two opposite longitudinal slots 117 are formed on an outer surface of the cylinder lock core 11. Two side bars 118 each comprises a spring 1181 on an inner surface at either end, and a flat inner side 1180 extending between the springs 1181. The expanding springs 1181 has open ends urged against an internal wall (not shown) of the slot 117 to lockingly dispose an outer side of the side bar 118 at the grooves 103 (see FIG. 1). Two sets of a plurality of (e.g., five) posts 123 are movably disposed in the auxiliary holes 116. The post 123 has a short cylinder 1231 projecting out of an inner surface proximate a bottom end, and a rectangular cut 1230 formed on an outer surface above the cylinder 1231. A distance from the cut 1230 to a top end of the post 123 is the same for all posts 123. But a distance from the cut 1230 to the cylinder 1231 is not the same for all posts 123. The key 13 has a lengthwise bending groove 131 on either side.

The key 13 may be fully inserted into the key hole 110 to cause its teeth 130 to push the lower tumbler elements 121 upward and to cause the bending grooves 131 to pass the cylinders 1231 to contain same therein. At this position, the cuts 1230 are flushed horizontally. Next, a user may rotate the key 13 and thus the cylinder lock core 11. And in turn, the expanded springs 1181 compress to pull the side bars 118 inward to cause the inner sides 1180 to enter the cuts 1230 and to cause the side bars 118 to clear the grooves (103) (see FIG. 1). As a result, the cylinder lock can be opened.

In an inoperative state of the cylinder lock (i.e., the key 13 is not inserted into the key hole 110), the posts 123 are of different elevations in the auxiliary holes 116. Hence, the cuts 1230 are not flushed horizontally. As a result, the side bars 118 are pushed outward to prevent the cylinder lock core 11 from rotating.

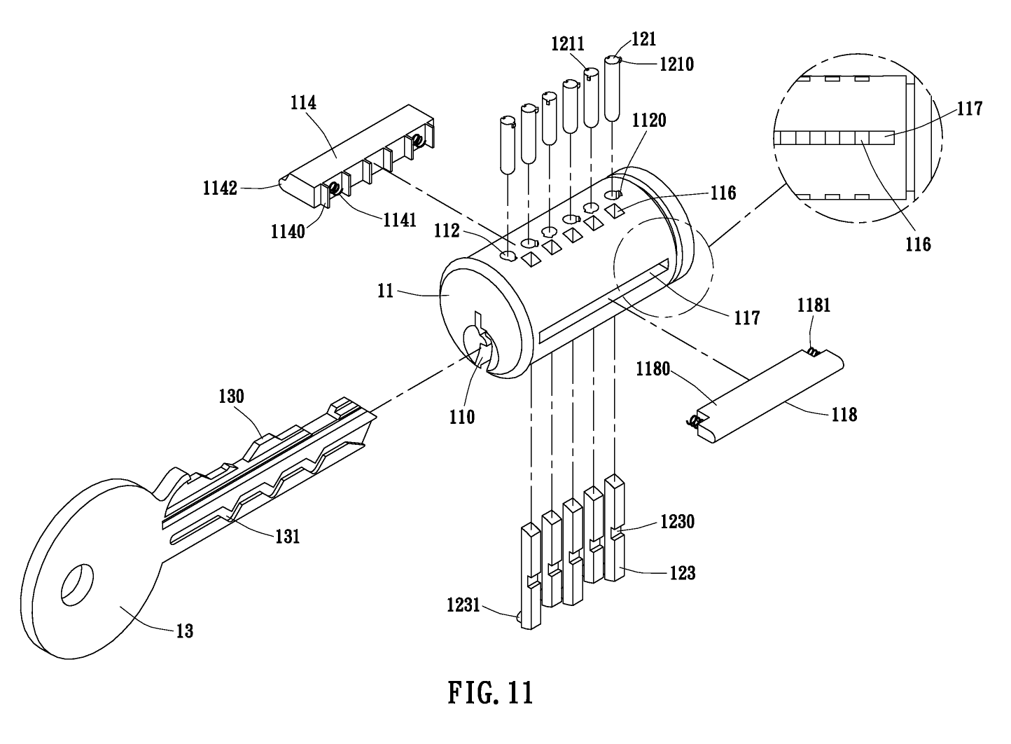

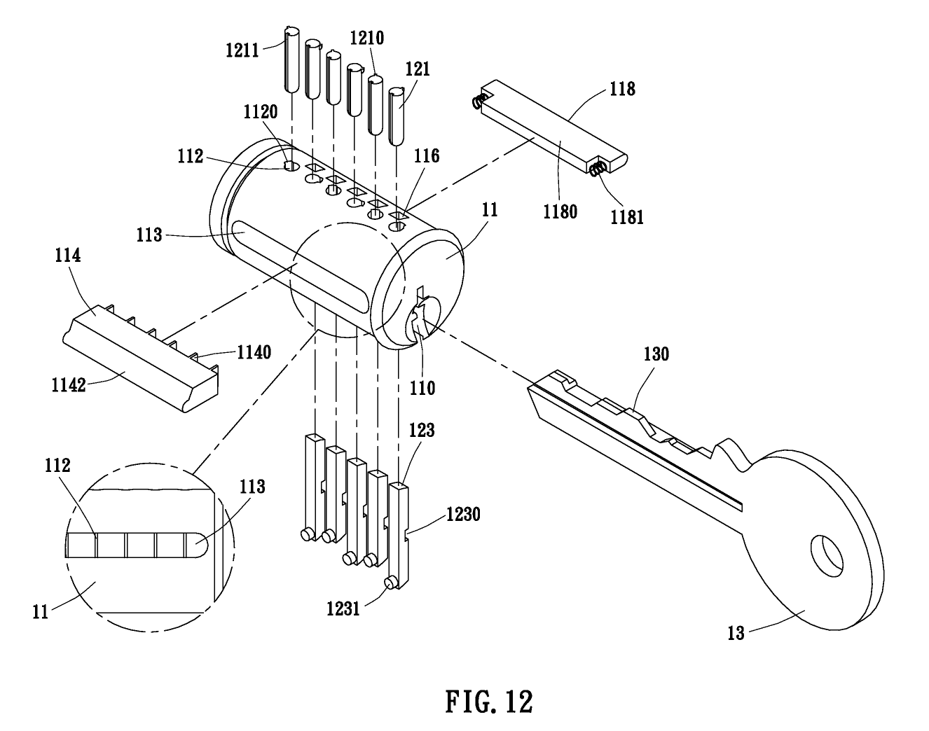

Referring to FIGS. 11 and 12, a cylinder lock in accordance with a fourth preferred embodiment of the invention is shown. The characteristics of the fourth preferred embodiment are detailed below. Note that a cylinder lock casing and a plurality of spring depressible upper tumbler elements of the cylinder lock of the fourth preferred embodiment are constructed the same as that described in the first preferred embodiment. Hence, description of the cylinder lock casing and the spring depressible upper tumbler elements of the cylinder lock of the fourth preferred embodiment are omitted herein for the sake of brevity only. The cylinder lock core 11 comprises a plurality of (e.g., six) lower tumbler elements 121 each having a longitudinal trough 1211 on an outer surface, and a protuberance 1210 on a top edge; a plurality of (e.g., six) lower holes 112 aligned along a top, each lower hole 112 having a recessed portion 1120 on a top edge; a plurality of (e.g., five) aligned auxiliary holes 116 at one side of the lower holes 112; a longitudinal first slot 113 at one side; a longitudinal second slot 117 at the other side; a second side bar 118 comprising a spring 1181 on an inner surface at either end, and a main body 1180 extending between the springs 1181, the expanding springs 1181 having open ends urged against internal walls (not shown) of the second slot 117 to lockingly dispose an outer side of the second side bar 118 at the mouth of the second slot 117; and a first side bar 114 having a substantially trapezoidal cross-section and comprising a plurality of (e.g., five) ribs 1140 equally spaced on an inner side, and a plurality of (e.g., two) helical springs 1141 in which one helical spring 1141 is provided between two front ribs 1140 and the other helical spring 1141 is provided between two rear ribs 1140. The first side bar 114 further comprises a longitudinal protrusion 1142 on an outer side. The ribs 1140 are disengaged from the troughs 1211 and the protrusion 1142 projects out of the first slot 113 when the cylinder lock is in a locked state.

A plurality of (e.g., five) posts 123 are movably disposed in the auxiliary holes 116. The post 123 has an inclined top end, a short cylinder 1231 projecting out of an inner surface proximate a bottom end, and a rectangular cut 1230 on an outer surface above the cylinder 1231. A distance from the cut 1230 to a top end of the post 123 is the same for all posts 123. But a distance from the cut 1230 to the cylinder 1231 is not the same for all posts 123. The key 13 has a lengthwise bending groove 131 on one side.

For opening the lock, a user may fully insert the key 13 into the key hole 110. The bending groove 131 may pass the cylinders 1231 to contain same therein. At this position, the cuts 1230 are flushed horizontally, the lower tumbler elements 121 are pushed upward to unlock the cylinder lock core 11. Next, a user may rotate the key 13 and thus the cylinder lock core 11. And in turn, the expanded springs 1181 compress to pull the second side bar 118 inward until the main body 1180 enters the cuts 1230 and the expanded helical springs 1141 compress to pull the first side bar 114 inward until the ridges 1140 enter the troughs 1211. As a result, the cylinder lock can be opened by further turning the key 13.

In an inoperative state of the cylinder lock (i.e., the key 13 is not inserted into the key hole 110), the posts 123 are of different elevations in the auxiliary holes 116. Hence, the cuts 1230 are not flushed horizontally. As a result, the second side bar 118 is pushed outward to prevent the cylinder lock core 11 from rotating. Also, the ribs 1140 are disengaged from in the troughs 1211 and the protrusion 1142 projects out of the first slot 113.

While the invention herein disclosed has been described by means of specific embodiments, numerous modifications and variations could be made thereto by those skilled in the art without departing from the scope and spirit of the invention set forth in the claims.

What is claimed is:

1. A cylinder lock comprising:
a cylinder lock casing (10) mounted in an object to be locked and comprising an axially extending cavity (100) of circular cross-section, two opposite lengthwise grooves (103) on an inner surface of the cavity (100), and a lengthwise riser (101) extending upward from the cavity (100), the riser (101) including a plurality of aligned upper holes (102) being in communication with the cavity (100);
a cylinder lock core (11) releasably fastened in the cylinder lock casing (10) and comprising a front key hole (110), a plurality of lower holes (112) aligned along a top, and a longitudinal slot (113) on one side of an outer surface, the slot (113) being in communication with the key hole (110);
a locking tumbler (12) comprising a plurality of cylindrical lower tumbler elements (121) slidably disposed in the lower holes (112), respectively, each of the lower tumbler elements (121) partially extended into the key hole (110) and including a longitudinal trough (1211) on an outer surface, and a plurality of spring depressible upper tumbler elements (120) in the upper holes (102), respectively, the upper tumbler elements (120) being partially disposed in the lower holes (112) and being in contact with the lower tumbler element (121), respectively; and
a spring depressible side bar (114) in the slot (113) and comprising a plurality of inner ribs (1140) spaced from the troughs (1211), respectively, and a longitudinal outer protrusion (1142) disposed in one groove (103),
whereby fully inserting a key (13) into the key hole (110) will cause teeth (130) of the key (13) to push the lower tumbler elements (121) into the lower holes (112) and cause the upper tumbler elements (120) to clear the lower holes (112), and turning the key (13) counterclockwise will cause the protrusion (1142) to clear one groove (103) so that the ribs (1140) may move into the troughs (1211) for engagement therewith, and wherein the counterclockwise turning of the key (13) will be stopped with the cylinder lock being opened when the protrusion (1142) enters the other groove (103).

2. The cylinder lock of claim 1, wherein each of the lower tumbler elements (121) further comprises an inclined bottom surface (1212), the bottom surfaces (1213) being shaped in conformity to the teeth (130) of the key (13).

3. The cylinder lock of claim 1, wherein each of the lower tumbler elements (121) further comprises a longitudinal ridge (1210) opposite the trough (1211), and each of the lower holes (112) comprises a longitudinal trough (1120) for matingly engaging with the ridge (1210).

4. The cylinder lock of claim 1, wherein each of the lower tumbler element (121) further comprises a longitudinal ridge (1210) opposite the trough (1211), and a recessed cross (1213) at the trough (1211) wherein the crosses (1213) of any two adjacent ones of the lower tumbler elements (121) have different elevations; wherein each of the lower holes (112) comprises a longitudinal trough (1120) for matingly engaging with the ridge (1210); and wherein each of the inner ribs (1140) is shaped as a raised cross (1143) adapted to matingly engage with the recessed cross (1213), any two adjacent ones of the raised crosses (1143) being of different in shape.

5. The cylinder lock of claim 1, wherein each of the lower tumbler elements (121) further comprises a recess (1214) on the trough (1211), any two adjacent ones of the recesses (1214) having different elevations; and wherein each of the ribs (1140) comprises a projection (1144) adapted to engage with the recess (1214).

6. A cylinder lock comprising:
a cylinder lock casing (10) mounted in an object to be locked and comprising an axially extending cavity (100) of circular cross-section, two opposite lengthwise grooves (103) on an inner surface of the cavity (100), and a lengthwise riser (101) extending upward from the cavity (100), the riser (101) including a plurality of aligned upper holes (102) being in communication with the cavity (100);
a cylinder lock core (11) releasably fastened in the cylinder lock casing (10) and comprising a front key hole (110), a plurality of lower holes (112) aligned along a top, two sets of a plurality of aligned auxiliary holes (116) at both sides of the lower holes (112), respectively, and two longitudinal slots (117) on both sides of an outer surface, respectively, the slots (117) being in communication with the key hole (110);
a locking tumbler (12) comprising a plurality of cylindrical lower tumbler elements (121) slidably disposed in the lower holes (112), respectively, each of the lower tumbler elements (121) partially extended into the key hole (110), a plurality of spring depressible upper tumbler elements (120) in the upper holes (102), respectively, the upper tumbler elements (120) being partially disposed in the lower holes (112) and being in contact with the lower tumbler element (121), respectively, and two sets of a plurality of posts (123) movably disposed in the auxiliary holes (116), respectively, each of the posts (123) including a lower cylindrical peg (1231) on an inner surface, and an upper cut (1230) on an outer surface wherein a distance from the cut (1230) of each of the posts (123) to a top end thereof is equal to a distance from the cut (123) of any one of the other posts (123) to a top end thereof, and a distance from the cut (1230) of each of the posts (123) to the peg (1231) thereof is not equal to a distance from the cut (123) of any one of the other posts (123) to the cut (123) thereof; and
two spring depressible side bars (118) in the slots (117), respectively, each of the side bars (118) having a flat inner side (1180),
whereby fully inserting a key (13) into the key hole (110) will cause teeth (130) of the key (13) to push the lower tumbler elements (121) into the lower holes (112) and cause the upper tumbler elements (120) to clear the lower holes (112), and cause a bending groove (131) on either side of the key (13) to pass the pegs (1231) and contain same therein, and turning the key (13) counterclockwise will cause the inner sides (1180) of the side bars (118) to enter the cuts (1230) for engagement therewith and cause one side bar (118) to clear one groove (103) and the other side bar (118) to clear the other groove (103), respectively, and
wherein the counterclockwise turning of the key (13) will be stopped with the cylinder lock being opened when one side bar (118) enters the other groove (103).

7. A cylinder lock comprising:
a cylinder lock casing (10) mounted in an object to be locked and comprising an axially extending cavity (100) of circular cross-section, two opposite lengthwise grooves (103) on an inner surface of the cavity (100), and a lengthwise riser (101) extending upward from the cavity (100), the riser (101) including a plurality of aligned upper holes (102) being in communication with the cavity (100);
a cylinder lock core (11) releasably fastened in the cylinder lock casing (10) and comprising a front key hole (110), a plurality of lower holes (112) aligned along a top, a plurality of aligned auxiliary holes (116) at one side of the lower holes (112), respectively, a longitudinal first slot (113) on one side of an outer surface, the first slot (113) being in communication with the key hole (110), and a longitudinal second slot (117) on the other side of the outer surface, the second slot (117) being in communication with the key hole (110),
a locking tumbler (12) comprising a plurality of cylindrical lower tumbler elements (121) slidably disposed in the lower holes (112), respectively, each of the lower tumbler elements (121) partially extended into the key hole (110) and including a longitudinal trough (1211) on an outer surface, and a plurality of spring depressible upper tumbler elements (120) in the upper holes (102), respectively, the upper tumbler elements (120) being partially disposed in the lower holes (112) and being in contact with the lower tumbler element (121), respectively, and a plurality of posts (123) movably disposed in the auxiliary holes (116), respectively, each of the posts (123) including a lower cylindrical peg (1231) on an inner surface, and an upper cut (1230) on an outer surface wherein a distance from the cut (1230) of each of the posts (123) to a top end thereof is equal to a distance from the cut (123) of any one of the other posts (123) to a top end thereof, and a distance from the cut (1230) of each of the posts (123) to the peg (1231) thereof is not equal to a distance from the cut (123) of any one of the other posts (123) to the cut (123) thereof;
a spring depressible first side bar (114) in the first slot (113) comprising a plurality of inner ribs (1140) spaced from the troughs (1211), respectively, and a longitudinal outer protrusion (1142) disposed in one groove (103), and
a spring depressible second side bar (118) in the second slot (117) and having a flat inner side (1180),
whereby fully inserting a key (13) into the key hole (110) will cause teeth (130) of the key (13) to push the lower tumbler elements (121) into the lower holes (112) and cause the upper tumbler elements (120) to clear the lower holes (112), and cause a bending groove (131) on the other side of the key (13) to pass the pegs (1231) and contain same therein, and turning the key (13) counterclockwise will cause the second side bar (118) to clear the other groove (103), cause the inner side (1180) of the second side bar (118) to enter the cuts (1230) for engagement therewith, cause the protrusion (1142) to clear one groove (103), and cause the ribs (1140) to move into the troughs (1211) for engagement therewith, and
wherein the counterclockwise turning of the key (13) will be stopped with the cylinder lock being opened when the second side bar (118) enters one groove (103).
